(19) United States
(12) Patent Application Publication
(10) Pub. No.: US 2009/0080683 A1
(43) Pub. Date: Mar. 26, 2009

(54) Wireless headset with microphone boom with new bending properties

(76) Inventors: Joeben Bevirt, Santa Cruz, CA (US); David Eliot Scheinman, Woodside, CA (US)

Correspondence Address: MICHAEL A. GUTH, 2-2905 EAST CLILFF DRIVE, SANTA CRUZ, CA, 95062, US

(21) Appl. No.: 12/077,059

(22) Filed: Mar. 14, 2008

Related U.S. Application Data
(60) Provisional application No. 60/918,114, filed on Mar. 14, 2007.

(51) Int. Cl. H04R 19/04

(52) U.S. Cl. 381/367

(57) ABSTRACT

A headset utilizing an extendable microphone boom that positions the microphone closer to the user's mouth when deployed. A wireless headset that is adjustable to the user's face and ear geometry through the use of a flexible joint between the headset housing and the earpiece. A wireless headset which uses a deployable microphone boom that deploys into a curved position. A wireless headset which utilizes a boom with material properties such that the boom may be easily placed into a position within a range, yet at the edges of this range have elastic properties.

### CROSS-REFERENCE TO RELATED APPLICATIONS

This application claims priority to U.S. provisional Application No. 60/918,114, filed Mar. 14, 2007, to the same inventors.

### BACKGROUND

1. Field of the Invention

The present invention relates to hands-free communication devices, and more particularly to a headset with microphone boom can be bent into position for a particular user.

2. Description of Related Art

A headset may be used in conjunction with a telephone device for several reasons. With a headset, the user is relived of the need to hold the phone and thus retains his or her hands free to perform other functions. Headsets also function to position the earphone and microphone portions of a telephone close to the user's head to provide for clearer reception and transmission of audio signals with less interference from background noise. Headsets may be used with telephones, computers, cellular telephones, and other devices.

The wireless industry has launched several after-market products to free the user form holding the phone while making phone calls. For example, various headsets are manufactured with an earpiece connected to a microphone and most of these headsets or hands-free kits are compatible with any phone brand or model. A possible headset can be plugged-in to the phone and comprise a microphone connected via wires to the headset so that the microphone, when in position, can appropriately capture the voice of the user. Other headsets are built in with a Bluetooth chip, or other wireless means, so that the voice conversation can be wirelessly diverted from the phone to the earpiece of the headset. The Bluetooth radio chip acts as a connector between the headset and a Bluetooth chip of the cell-phone.

A drawback of many of the available headsets is that they are either very large, or, if smaller, place the microphone of the headset far from the user's mouth, which may introduce noise problems into the communication system. Another drawback to available headsets is the lack of adjustment in the headset to the user's facial and head geometry.

What is called for is a wireless headset that is both very small but also allows for placement of the microphone closer to the user's mouth. What is also called for is a headset which flexes to conform to the user's facial geometry.

### SUMMARY

A headset utilizing an extendable microphone boom that positions the microphone closer to the user's mouth when deployed. A wireless headset that is adjustable to the user's face and ear geometry through the use of a flexible joint between the headset housing and the earpiece. A wireless headset which uses a deployable microphone boom that deploys into a curved position. A wireless headset which utilizes a boom with material properties such that the boom may be easily placed into a position within a range, yet at the edges of this range have elastic properties.

### BRIEF DESCRIPTION OF THE DRAWINGS

FIGS. 1A-B are headsets seen being worn by a user according to some embodiments of the present invention.

FIGS. 2A-B are sketches of a headset according to some embodiments of the present invention.

FIGS. 3A-B are sketches of a headset with its microphone boom both stowed and extended according to some embodiments of the present invention.

FIG. 4 is a sketch of a headset according to some embodiments of the present invention.

FIG. 5 is a sketch of headset according to some embodiments of the present invention.

FIG. 6 is a sketch of headset according to some embodiments of the present invention.

FIGS. 7A-D illustrate the internal configuration of a headset according to some embodiments of the present invention.

FIGS. 8A-C illustrate a headset with an earloop according to some embodiments of the present invention.

### DETAILED DESCRIPTION

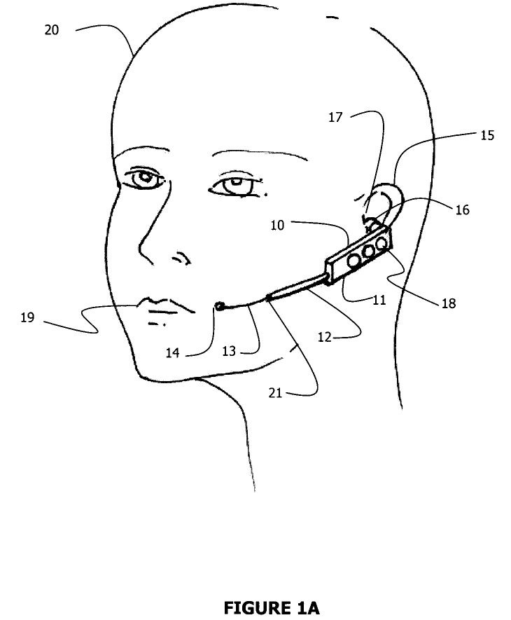

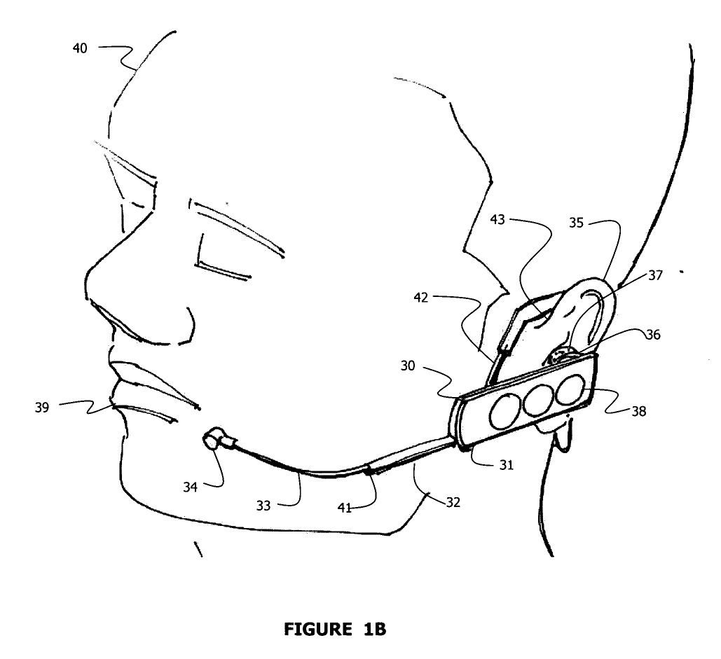

FIG. 1A illustrates a user wearing a headset according to some embodiments of the present invention. The headset 10 is adapted to attach to the user's ear 15. The earpiece 16 is adapted to fit into the ear canal 17. In some embodiments, the headset 10 is wholly supported on the user's head 20 by the fit of the earpiece 16 into the ear canal 17. The microphone boom 21 is seen in the deployed position. A first boom section 12 extends from the main body 11. A second boom section 13 extends from the first boom section 12. A microphone 14 is attached to the second boom section 13. The deployment of the microphone boom 21 places the microphone 14 in closer proximity to the user's mouth 19, which may be advantageous with regard to suppression of outside noise during communication, and also may allow the user to talk more quietly when using the headset in a public area.

The main body 11 of the headset 10 may have one or more buttons 18 which may be used to control aspects of the headset's function. The deployable nature of the microphone boom 21 allows for a very small headset. The microphone boom 21 may be stowed into or along the main body 11 of the headset. The headset may then be carried with minimal risk to the microphone boom 21, and the small size of the main body 11 of the headset 10 affords the user the convenience of having a very small package. The extendable nature of the microphone boom combines the convenience of a very small, lightweight package with the advantage of a microphone close to the user's mouth when the microphone is deployed. In some embodiments, there may be a second microphone mounted on or near the main body as well. The second microphone may be used in conjunction with the first microphone in a noise suppression regime implemented by the electronics within the main body. In some embodiments, the second microphone may be set with a different gain, and is used when the microphone boom is not deployed, with the first microphone switched on when the microphone boom is deployed. In some embodiments, the microphone 14 on the deployable boom may be adapted at a first gain level when stowed, and at a second gain level when deployed.

As seen in FIG. 1A, the microphone boom 21 may be curved when deployed to follow at least in part the contours of the user's face and to place the microphone 14 closer to the user's mouth 19. This position may be of advantage with regard to the functioning of the microphone, and may also allow for more convenience for the user physically. In some embodiments, the second boom section 13 stows within the first boom section 12. In some embodiments, the boom sections are substantially straight when stowed within the main body 11. The boom sections may both be curved when deployed, or only one of the boom sections may be curved when deployed.

FIG. 1B illustrates a user wearing a headset according to some embodiments of the present invention. The headset 30 is adapted to attach to the user's ear 35. The earpiece 36 is adapted to fit into the ear canal 37. The headset 30 is also supported on the user's head 40 by the fit of an earloop 42 over the top 43 of the ear 35. The microphone boom 41 is seen in the deployed position. A first boom section 32 extends from the main body 31. A second boom section 33 extends from the first boom section 32. A microphone 34 is attached to the second boom section 33. The deployment of the microphone boom 41 places the microphone 34 in closer proximity to the user's mouth 39, which may be advantageous with regard to suppression of outside noise during communication, and also may allow the user to talk more quietly when using the headset in a public area. The main body 31 of the headset 30 may have one or more buttons 38 which may be used to control aspects of the headset's function. The deployable nature of the microphone boom 41 allows for a very small headset. The microphone boom 41 may be stowed into or along the main body 11 of the headset.

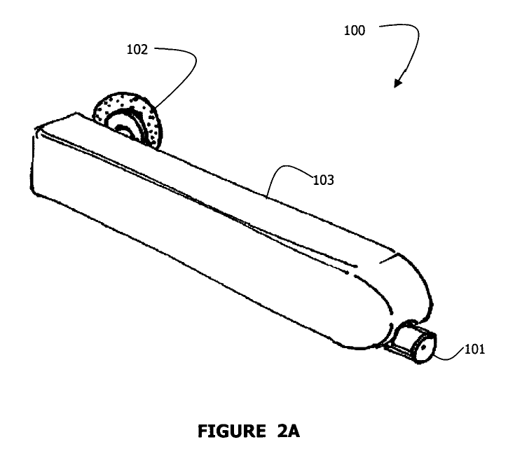

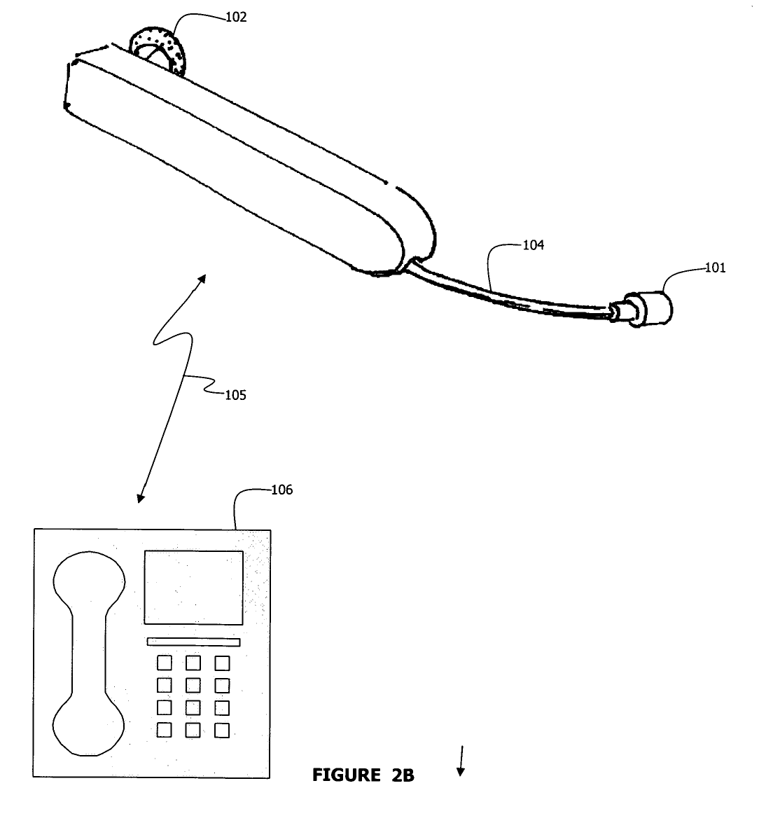

FIG. 2A shows a headset 100 according to some embodiments of the present invention. The headset is adapted for wireless communication. The headset may be used with a Bluetooth enabled system such that a voice conversation on a Bluetooth enabled cell-phone is diverted away from the cell-phone and rendered to the user via the headset. However, the headset is not limited in this fashion and may communicate with other types of devices, including but not limited to a personal digital assistant, an MP-3 player, or other system. As seen in FIG. 2B, the headset 100 communicates with a device 106 over an RF spectrum 105. The headset 100 has a main body 103 connected to an earpiece 102. A microphone 101 is attached to a microphone boom 104 which is extended from a stowed position within the housing in some embodiments. In some embodiments, the main body 103 is approximately 2.5 inches in length along its long axis. The microphone boom 104 may be substantially as long as the main body 103, or approximately 2 inches.

The microphone boom 104 is curved in some embodiments. The microphone boom 104 may be comprised of a shaped memory alloy (SMA). The SMA may be a nickel (Ni) Titanium (Ti), or NiTi alloy. A generic trade name for NiTi alloys is Nitinol. NiTi alloys may have a property called pseudoelasticity, also called superelasticity. Superelasticity describes a non-linear recoverable deformation behavior at temperatures above a certain temperature, which arises from a stress-induced martensitic transformation on loading and the spontaneous reversion of the transformation upon unloading. The use of an SMA in the microphone boom 104 allows for the boom to be substantially straight while stowed and curved while deployed. The stowed boom may be constrained into a straight shape while stowed, and free to take its curved shape when deployed. The boom curve is preset into the superelastic material. The curve of the microphone boom 104 may be adapted to curve along the face of the user towards the mouth of user. The curved shape may both enhance the functionality of the boom and microphone, and may also reduce the likelihood of damage that may occur with a straight boom that sticks further out from the user's face. The microphone boom 104 may use a single piece of NiTi alloy in some embodiments. The microphone boom may be restrained from rotating to ensure that the boom, when deployed and curved, is in a preferred position relative to the main body of the headset. In some embodiments, the microphone boom may have some rotational freedom to allow the user to adjust the position of the microphone somewhat.

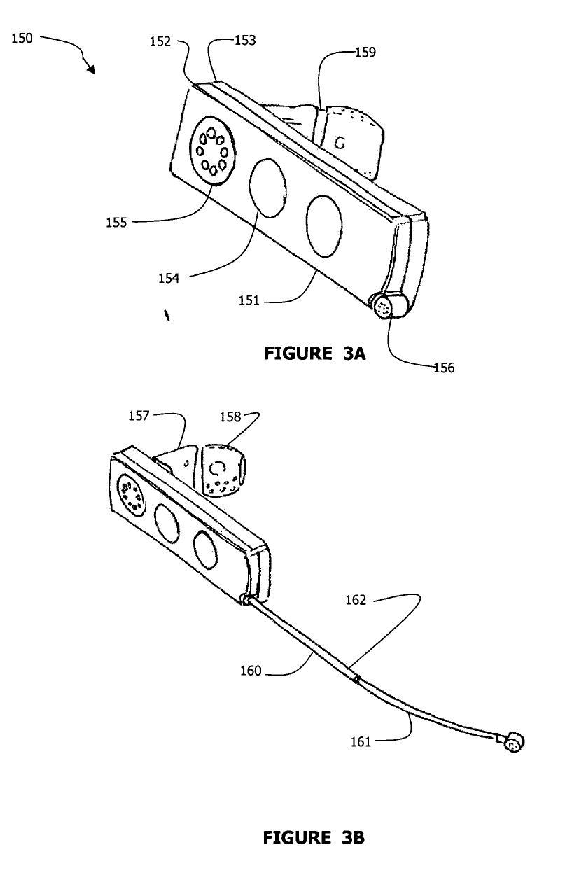

FIGS. 3A-B further illustrate a headset 150 according to some embodiments of the present invention. The main body 151 may consist of an inner housing 153 and an outer housing 152. One or more of the housing pieces may be made from metal. The inner housing 153, which is the side of the main body 151 adjacent to the user's head, may be made of metal in part to provide a shield for the RF emissions from the headset relative to the user. The use of a metal, such as magnesium, housing may give an additional advantage of allowing for a very thin wall thickness which may facilitate the construction of a very small headset. In some embodiments, a magnetically permeable metal may used. This may be used in conjunction with accessories which use a magnet to attach to the housing. An earpiece 159 is attached to the main body 151. One or more buttons 151, 154 may be positioned on the outer housing 152 of the main body 151 and may be used to implement functionalities of the headset 150. An LED panel 155 may indicate function. A microphone 156 is seen in the stowed position in FIG. 3A. The microphone boom has been stowed into the main body 151. The microphone is seen to be at an inner edge of the main body 151, and not in the center of the main body. In some embodiments, the microphone boom may stow into a position along the main body. The earpiece 159 consists of an earpiece base 157 and an ear engaging body 158. The earpiece 159 may be attached to the main body 151 with a flexible joint. The flexible joint may allow the relative position and angle of the main body of the headset and the earpiece to be adapted for user's with differing ear shapes and geometries. The ear engaging body 158 may be adapted to fit into the ear canal of the user, and may be adapted to support the headset on the user's head without additional attachments in some embodiments. In some embodiments, additional attachments may be used with the headset.

FIG. 3B illustrates the headset 150 with the microphone 156 in the deployed position. The microphone 156 can be seen now deployed from the main body 151. The microphone 156 has been deployed with an extendable microphone boom 162 which was stowed within the main body 151. The microphone boom 162 consists of a first boom section 160 and a second boom section 161. The microphone boom 162 is a telescoping boom in this embodiment; the second boom section 161 stows into the first boom section 160 when the microphone boom 162 is stowed. In some embodiments, both boom sections are made from a superelastic material. In some embodiments, one or both of the boom sections may be curved in their deployed state. In some embodiments, the boom may be restricted from rotation relative to the main body 151. In some embodiments, the boom sections may be restricted from rotation relative to each other. This may be accomplished by having the telescoping sections be made from an oval profile, or through other methods. In some embodiments utilizing a telescoping microphone boom, the microphone boom may be substantially longer than the length of the main body of the headset along its long axis. For example, the main body of the headset, with the microphone stowed and the microphone boom within the main body, may be approximately 2.5 inches in length. The microphone boom may extend out approximately 4 inches in such an embodiment. In some embodiments, the second boom section 161 is curved in its relaxed state, and the first boom section 160 is straight. The second boom section 161 is straightened as it is stowed back into the first boom section 160, and in turn as both boom sections are stowed back into the housing.

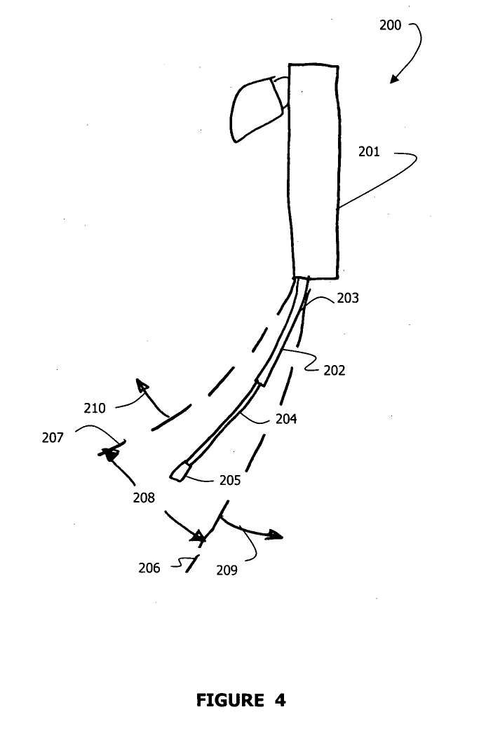

FIG. 4 illustrates a headset 200 according to some embodiments of the present invention. The headset main body 201 is seen with a microphone boom 202 in a deployed position. The microphone boom 202 may be constructed of a first section 203 and a second section 204. Both sections may be hollow cylinders in some embodiments. A microphone 205 is seen attached to the far end of the second section 204 of the boom 202. Wiring for the microphone 205 may be contained within the tubing of the boom 202. The microphone boom 202 is seen in its nominally curved position, the position in which it was set during its initial heat treatment. As discussed below, the boom 202 has undergone further treatment.

The microphone boom has been designed to allow for some particularly useful properties. To allow for further adaptability of the headset 200 to the particular facial geometry and preferences of a user, the boom may be easily positioned within a central range 208. The central range 208 may have a first end 206 and a second end 207. Within the central range 208, the boom may be easily pushed into a position desired by the user, and it will stay in that position. Thus, an individual user may set the boom to a position that the user finds comfortable or otherwise appropriate for use. When the boom is pushed past the limits 206, 207 of the central range 208, into the areas 209, 210 outside the central range 208, the boom will have elastic properties. The boom may pushed far outside the central range 208 and will spring back to, or near to, the limit area of the central range. The center of this central range 208 may be the nominal original position set during the first heat treatment.

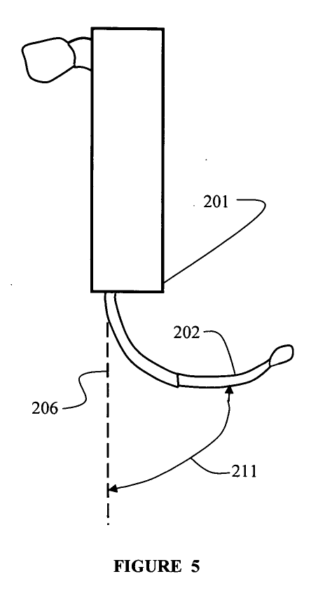

FIG. 5 illustrates an aspect of this property. The boom 202 is shown quite bent into a position 211 well beyond the limit 206 of the central range. The boom 202 will only maintain this position if held there. Upon release, the boom 202 will spring back to, or very near to, the limit 206 of the central range. While the position 211 may be somewhat exaggerated for demonstration purposes, it is important to note that the boom 202 may be of a material such that significant and very large deformations in the boom may be made without exiting the elastic range.

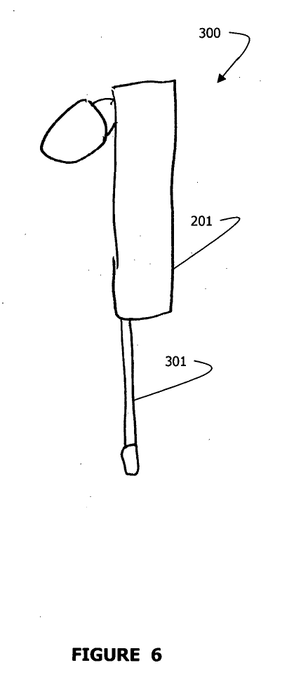

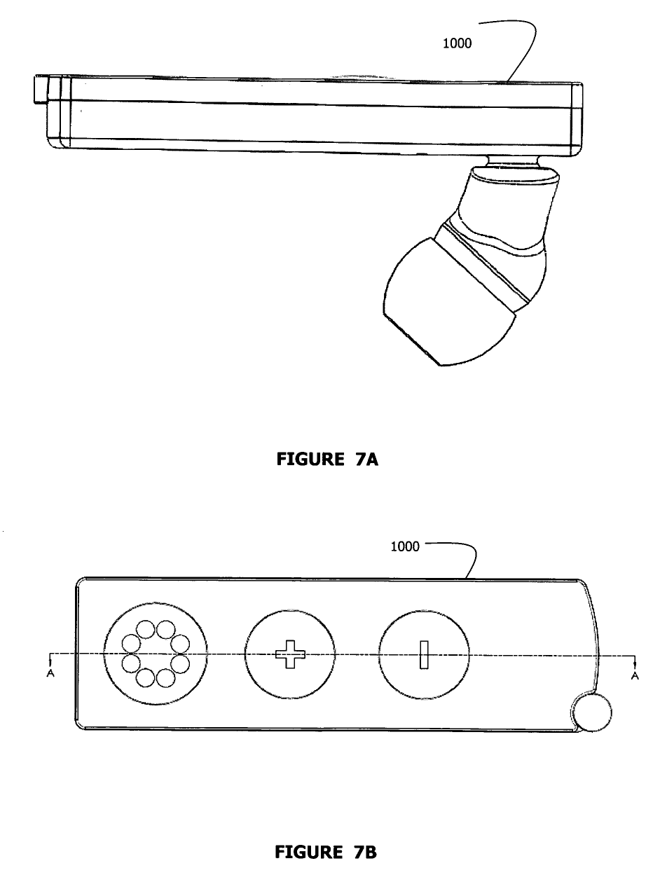

Although the boom with the central range and properties as described about was described in the context of a two part boom, it is understood that the boom may be made of a single piece. The boom may be deployable and retractable according to embodiments of this invention or may be deployed at all times. As seen in FIG. 6, a headset 300 with a main body 201 and a single piece boom 301. The single piece boom 301 may be made with the material properties as described for the boom 202. Other boom designs, for example those such as seen in U.S. patent application Ser. No. 11/488,957 to Bevirt et al., with a filing date of Jul. 9, 2006, of which this application is a continuation in part, may utilize a boom with the new material properties disclosed herein.

An exemplary embodiment of the boom 202 is as follows. The first section 203 has an outside diameter of 1.40-1.44 mm, a wall thickness of 0.07-0.12 mm, and a length of 48 mm. The second section 204 has an outside diameter of 1.08-1.12 mm, and wall thickness of 0.07-0.12 mm, and a length of 47.5 mm. The material is a NiTi material starting with an ingot of binary NiTi alloy produced by smelting Sponge Ti and electrolytic Ni. The ingot is forged into a 35 mm diameter rod, rolled into a thin 8 mm diameter NiTi rod, a hole is then put into the rod to form a tube, and then the tube is drawn into the tubing of the desired geometry over several steps. The initial treatment is the same as would be used to set the bend in the booms 104, 162 above. The tubing is placed in a form, which holds it in a curved position, and treated. The initial treatment is a heat treatment of about 480-580 C for 10-30 minutes. This initial treatment sets the bend of the aforementioned booms. A further treatment is used to create the central region of inelastic deformation around the set bent shape. The material is then heat treated at 300-550 deg C. for 30 min to 2 hours. After the second treatment, the central region of inelastic deformation will be seen in the material.

A typical material will have a central bending range that is elastic, wherein small deflections behave in a spring like fashion. As the material is deflected further, an elastic limit is reached wherein the stress has exceeded the amount under which the material retains its elastic properties. With further deflection, plastic deformation occurs, and the material will not return to its original position upon unloading.

A superelastic material, such as Nitinol (NiTi) may exhibit elasticity over large levels of strain. The increased flexibility obtained in these materials by undergoing large elastic strain can improve their performance. At low levels of stress, the material exits in an austenite phase. Upon further loading, the material undergoes a stress-induced transformation from the austenite phase to a martensite phase. The material behaves as linear elastic in both austentite and martensite phases, however, the modulus of elasticity in the two phases is different. During the stress induced transformation from austenite to martensite there is very little change is stress, but a large increase in strain. Beyond the transitions region in the martensite phase ultimately results in permanent unrecoverable set in the material, while unloading for cases that do not reach the transformation state follow the elastic modulus.

The booms illustrated in FIGS. 2 and 3 utilize a first material as described above. Thus, the boom can have been preset in a curved shape, and can be stowed in a straight shape. The straight shape is within the superelastic range for the boom. The straight shape stowage of the boom may be required or preferred in order to fit it into the headset main body, especially a small, crowded, headset main body.

The boom as illustrated in FIGS. 4 and 5 behaves differently and offers other distinct advantages. The central inelastic range allows the user to position the microphone around the user's face in a manner that is more specific to a particular user. For example, the material may be bent at differing radii of curvature at different points along the length of the boom. Also, although the boom is positionable in this central range, the boom will be exceptionally durable for the consumer because the elastic properties outside the central range will greatly lower the likelihood of damage to the boom if it is sat upon or otherwise mistreated by the user. Another advantage of this central range is that is in essence limiting the choices the user may have to “mis-position” the microphone. A user tempted to bend the microphone to a position far from his face will do so only to have it spring back to the outer edge of the central range. This allows the microphone to remain in a range where it is likely to function better, and keeps the microphone out of substantially less optimal positions.

The properties of the booms 202, 301 with the central range may be due to the setting of the martensite start (Ms) and the austenite finish (Af) temperatures. In most cases, a material will demonstrate elastic properties immediately upon the onset of strain. However, it is possible to set the material properties such that this is not the case, and that some strain must be added before the material moves into its pseudo-elastic range. This may then allow for inelastic material properties in a central range, and after the addition of enough strain induced stress, such as by moving through this central range, the elastic properties are seen. The effects described with regard to the booms 202, 301 above may be due to having room temperature (or the boom operation temperature) lying between the Ms and Af temperatures.

The inelastic properties in the central range are most probably a result of this being a region where the NiTi alloy is transitioning from austenite to a martensite phase. The highly elastic properties outside the central range are most probably due to an elastic martensite deflection, although the invention is not limited to a single theory.

As the stress during bending is related to the bending section, with material furthest from the bending center seeing the highest stress under bending, the breadth of the central inelastic range may be altered depending upon the selected bending section. For example, a smaller diameter tube will bend further before a certain stress is reached relative to a larger diameter tube. Thus, through manipulation of the bending cross-section one can manipulate the breadth of the central range.

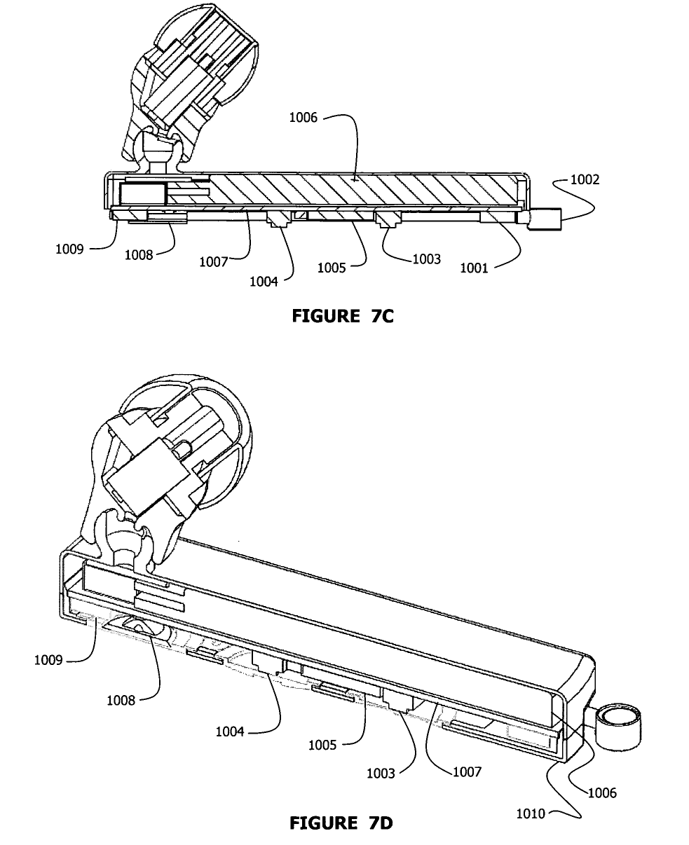

FIGS. 7A-D illustrate a headset according to some embodiments of the present invention including the internal configuration for a miniature headset configured for wireless use. FIG. 7A illustrates a side view of a miniature headset with a stowed microphone and an earpiece connected to the main body with a flexible joint according to some embodiments of the present invention. FIG. 7B illustrates a back view of a headset 100 showing two button switches and an LED panel. FIGS. 7C and D illustrate a cutaway view of the headset 1000 in orthogonal and perspective view, respectively, demonstrating an internal configuration. The housing 1010 contains electronics and other components adapted for wireless communication. A pc board 1007 is seen with an integrated circuit 1005 mounted thereon. In some embodiments, the integrated circuit 1005 is adapted for Bluetooth communication. A battery 1006 provides power for the headset. The limit switch 1009 is used to alter the gain for the microphone 1002 depending upon whether it is stowed or deployed. Two switches 1003, 1004 are used to allow for inputting direction from the outside of the headset using buttons. An three color LED 1008 is used to visually indicate functionalities to the user. An antenna 1001 is also mounted to the pc board 1007. One can see that the housing 1000 has been elegantly packed to provide for full functionality in a very small package.

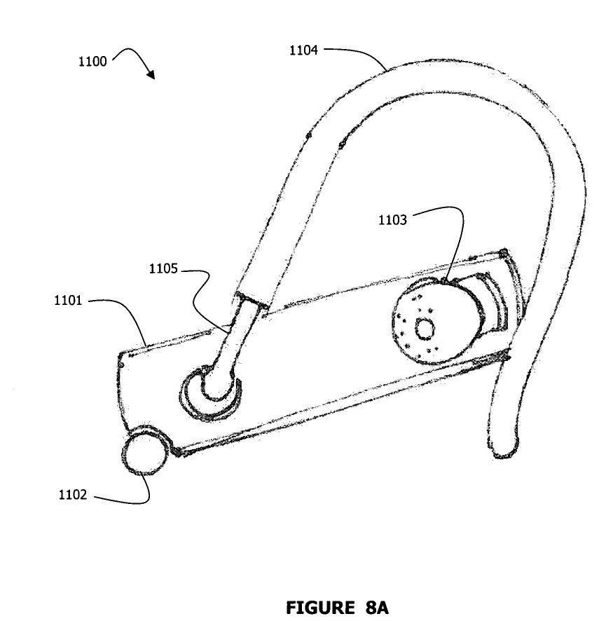

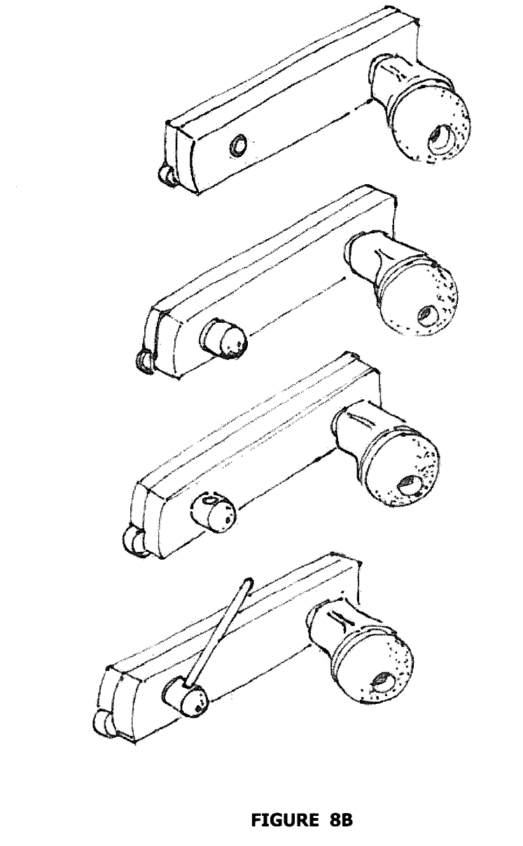

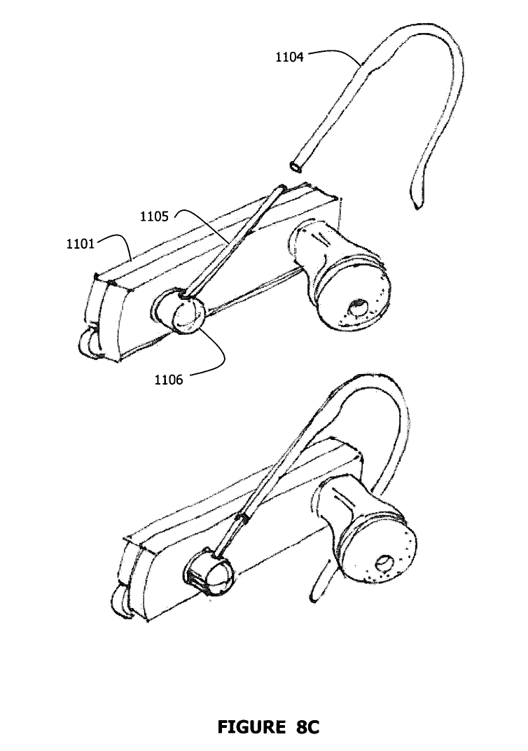

FIGS. 8A-C illustrate a headset 1100 with an earloop 1104 according to some embodiments of the present invention. The main body 1101 is attached to an earpiece 1103. In some embodiments, the earpiece 1103 is attached with a flexible joint. The microphone 1102 is seen at one end of the main body 1101. In some embodiments, the microphone 1102 will deploy in accordance with other aspects of embodiments of the present invention. A bulb 1106 is adapted to position a cheek pin 1105 along the inner surface of the main body 1101 of the headset 1100. An earloop 1104 is placed over the cheek pin 1105 and is adapted to support the headset over the user's ear.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

We claim:

1. A headset comprising:
a main body;
a microphone; said microphone attached to a microphone boom; and
a microphone boom, said microphone boom attached to said main body, said microphone boom having an inelastic central bending range.

2. The headset of claim 1 wherein said microphone boom has an outer elastic bending range, wherein said outer elastic bending range is outside of said inelastic central bending range.

3. The headset of claim 2 wherein said microphone boom comprises a shape memory alloy.

4. The headset of claim 2 wherein said microphone boom comprises nitinol.

5. The headset of claim 2 wherein said microphone boom comprises an extendable boom, said extendable boom adapted to deploy from a first position substantially within said main body to a second position outside of said main body.

6. The headset of claim 5 wherein said extendable boom comprises:
a first boom section; and
a second boom section, said second boom section adapted to telescope within said first boom section.

7. The headset of claim 1 further comprising an earpiece for providing an audio output, said earpiece attached to said main body.

8. The headset of claim 7 wherein said earpiece is attached to said main body with a ball and socket joint.

9. The headset of claim 4 wherein said boom comprises a tubular cross-section.

10. The headset of claim 9 wherein said tubular cross-section has a wall thickness in the range of 0.07 mm to 0.12 mm.

11. The headset of claim 9 wherein said tubular cross-section has an outside diameter in the range of 1.0 mm to 1.5 mm.

12. The headset of claim 10 wherein said tubular cross-section has an outside diameter in the range of 1.0 mm to 1.5 mm.

13. The headset of claim 2 wherein said boom is curved.

14. A headset comprising:
a main body;
a microphone; said microphone attached to a microphone boom; and
a microphone boom, said microphone boom attached to said main body, said microphone boom comprising a shape memory alloy.

15. The headset of claim 14 wherein said shape memory alloy comprises NiTi alloy.

16. The headset of claim 15 wherein the martensite start temperature of the NiTi alloy is below 20 degrees Celsius, and wherein the austenite finish temperature of the NiTi alloy is above 20 degrees Celsius.

17. The headset of claim 14 wherein the martensite start temperature of said shape memory alloy is below 20 degrees Celsius, and wherein the austenite finish temperature of said shape memory alloy is above 20 degrees Celsius.

18. A headset comprising:
a main body;
a microphone; said microphone attached to a microphone boom; and
a microphone boom, said microphone boom attached to said main body, said microphone boom having a predominantly inelastic central bending range, and wherein said microphone boom has a predominantly elastic outer bending range, wherein said outer elastic bending range is outside of said inelastic central bending range.

19. The headset of claim 18 wherein said microphone boom comprises a shape memory alloy.

20. The headset of claim 19 wherein said microphone boom comprises nitinol.
